(19) United States
(12) Patent Application Publication
(10) Pub. No.: US 2008/0264418 A1
(43) Pub. Date: Oct. 30, 2008

(54) Y-PIECE FOR MEDICAL RESPIRATION SYSTEMS

(75) Inventors: Olaf SCHERMEIER, Lubeck (DE); Henning GERDER, Lubeck (DE); Hans Ullrich HANSMANN, Barnitz (DE)

Correspondence Address: MCGLEW & TUTTLE, PC, P.O. BOX 9227, SCARBOROUGH STATION, SCARBOROUGH, NY, 10510-9227, US

(73) Assignee: DRAGER MEDICAL AG & CO. KG, Lubeck (DE)

(21) Appl. No.: 12/061,894

(22) Filed: Apr. 3, 2008

(30) Foreign Application Priority Data
Apr. 27, 2007 (DE) 10 2007 019 962.9

(51) Int. Cl. A62B 7/00

(52) U.S. Cl. 128/204.21

(57) ABSTRACT

A Y-piece (1) is provided that can be used for a medical respiration (ventilation) system. An electric interface is provided between one or more sensors (9, 10, 11, 12, 15, 16), connected to the Y-piece (1), and a contactless connection element (4). The contactless connection element (4) provides a connection from the inspiration branch and/or to the expiration branch to a flexible breathing tube (3) of the respiration system.

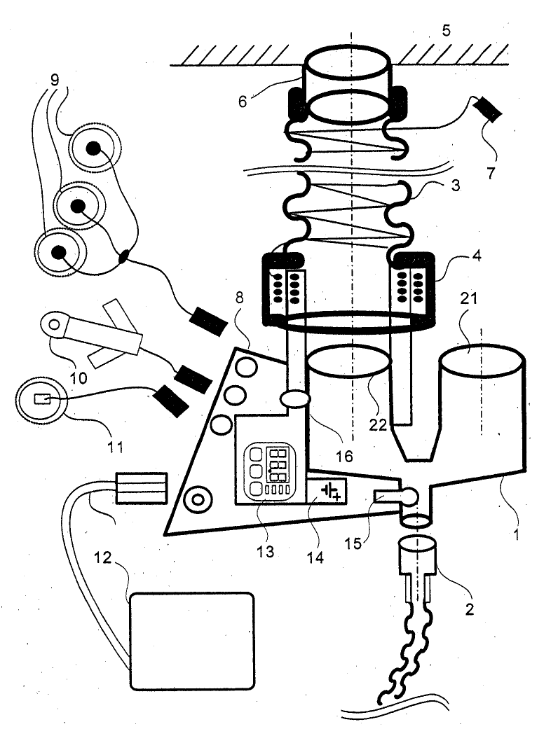

### CROSS REFERENCE TO RELATED APPLICATIONS

This application claims the benefit of priority under 35 U.S.C. § 119 of German Patent Application DE 10 2007 019 962.9 filed Apr. 27, 2007, the entire contents of which are incorporated herein by reference.

### FIELD OF THE INVENTION

The present invention pertains to a Y-piece for medical respiration (also known as ventilation) systems, which is usually arranged as a pneumatic bridging element between the breathing tube at or to the patient and an inspiration branch and an expiration branch from or to a respirator or anesthesia apparatus.

### BACKGROUND OF THE INVENTION

A flexible breathing tube with an inductive interface is described in DE 103 128 81 B3.

It is usually necessary for supplying patients in an intensive care unit in a hospital to monitor both various vital functions and also to support or replace the especially important vital function of respiration.

The vital functions are detected by means of physiological measured data with corresponding sensor systems; these are, for example, ECG monitoring, measurement of the pulse rate, the temperature and the oxygen partial pressure.

The mechanical respiration of a patient is carried out by means of a respirator or anesthesia apparatus.

The monitoring of the patient or the monitoring and the mechanical respiration are carried out by means of various, independent devices operating separately from one another for detecting the various sensor data, on the one hand, and by means of a respirator or anesthesia apparatus for applying the breathing gases, pressure levels and volumes for the mechanical respiration, on the other hand.

The separate handling or the separate energy and data supply and transmission via a plurality of cables from the commercial power supply to the individual devices as well as from the devices to the patient is ergonomically unfavorable and confusing and could lead to errors or accidents.

### SUMMARY OF THE INVENTION

The object of the present invention is to improve a medical workstation for a mechanically respirated patient monitored by means of sensors in respect to the handling of the devices used, the possibility of setting up and dismantling such devices and ultimately the access to the patient.

According to the invention, a Y-piece for medical respiration systems is designed as an electrical interface between one or more sensors connected to the Y-piece for patient monitoring and a contactless connection element to the inspiration branch and/or expiration branch.

The Y-piece comprises an inspiration branch, an expiration branch and a Y-piece contactless connection element portion. The electrical interface provides a connection between one or more sensors connected to the Y-piece and a contactless connection element portion of a flexible breathing tube connected to at least one of the inspiration branch and the expiration branch via the Y-piece contactless connection element portion.

The connection element may advantageously comprise an inductive or capacitive element. The electrical interface may comprise an energy and data interface.

The sensors may comprise at least one of carbon dioxide sensors, oxygen partial pressure sensors and temperature sensors. The electrical interface may comprise electric outlets for ECG electrode cables and sensor connections of the sensors.

The Y-piece may advantageously further comprise a mount for a sphygmomanometer cuff with a flexible tube.

A breath flow sensor may also be provided, arranged in a flow path of the Y-piece. The breath flow sensor may comprise a sensor for detecting a velocity of gas passing through the flow path, for detecting a quantity of gas passing through the flow path, for detecting a type of gas passing through the flow path and/or for detecting a gas concentration of gas passing through the flow path. The breath flow sensor may advantageously be one or more of a hot wire anemometer, an ultrasound anemometer and/or a differential pressure anemometer.

The Y-piece may advantageously further comprise a pressure sensor for detecting the respiration pressure.

The Y-piece may advantageously further comprise an electronic unit for processing measured signals arriving from the sensors. The electronic unit may comprise at least one of: an ECG operating electronic unit containing a differential amplifier, compensation circuits and an analog-digital converter and a control computer; and an oxygen partial pressure operating electronic unit containing an LED driver and control, photodiode amplifier, analog-digital converter, and control computer. An electrical energy storage means may be connected to the electronic unit.

Another flexible breathing tube may be provided wherein each of the inspiration branch and the expiration branch are connected via the Y-piece contactless connection element portion to a respective flexible breathing tube. Each contactless connection element provides inductive or capacitive connections.

The electrical interface elements may advantageously comprise the electrical interface embedded in a housing of the Y-piece. The electrical interface elements may be designed in the form of a unit that can be attached to, plugged into or docked with the housing of the Y-piece.

According to another aspect of the invention, a medical respiration system is provided comprising a Y piece including a Y-piece housing defining an inspiration branch an expiration branch and a patient connection branch. A Y-piece contactless connection element portion is connected to one of the inspiration branch and the expiration branch. An electrical interface is connected to the Y-piece housing and connected to the Y-piece contactless connection element portion. The electrical interface has sensor connection means and provides a connection between the sensor connection means and the Y-piece contactless connection element portion. One or more sensors are connected to the connection means of the electrical interface. A flexible breathing tube is connected to at least one of the inspiration branch and the expiration branch. A tube contactless connection element portion is operatively connected to the Y-piece contactless connection element portion.

An exemplary embodiment will be explained below on the basis of the sole FIGURE. The various features of novelty which characterize the invention are pointed out with particularity in the claims annexed to and forming a part of this disclosure. For a better understanding of the invention, its operating advantages and specific objects attained by its uses, reference is made to the accompanying drawing and descriptive matter in which a preferred embodiment of the invention is illustrated.

### BRIEF DESCRIPTION OF THE DRAWINGS

In the drawings:

The only FIGURE is a schematic view showing the design and the arrangement of the Y-piece between the patient-side respiration tube and the inspiratory or expiratory flexible breathing tube according to the invention.

### DESCRIPTION OF THE PREFERRED EMBODIMENT

Referring to the drawings in particular, The Y-piece 1 has an inspiratory leg 21 and an expiratory leg 22 as well as a patient-side connection for the pneumatic port to the breathing tube 2 or the connection piece thereof.

The FIGURE shows the pneumatic port 6 of a respirator or anesthesia apparatus 5. For example, the flexible breathing tube 3 in the expiratory branch connects the expiratory leg 22 of the Y-piece 1 to the pneumatic port 6 of the respirator or anesthesia apparatus 5. An electric terminal 7 for data exchange and supply voltage via wire lines in the flexible breathing tube 3 is provided at the respirator or anesthesia apparatus 5.

The flexible breathing tube 3 has an inductive or capacitive connection, which is always contactless, to the connection element 4 of the Y-piece 1 for data and/or energy transmission.

An electronic unit with electrical plug mounts 8, for example, for ECG electrode terminals 9, for an oxygen partial pressure sensor 10 and/or for a temperature sensor 11 is integrated in the Y-piece 1. Another mount maybe provided, for example, for a sphygmomanometer cuff 12 with a flexible tube for measuring the blood pressure.

A breath flow sensor 15, for example, a hot wire anemometer, is arranged in the path of flow of the Y-piece 1.

The breath flow sensor 15 may also be a differential pressure or ultrasound anemometer.

A pressure sensor 16 is preferably provided for detecting the respiration pressure.

The electronic unit 13 with memory is integrated in the Y-piece 1 and is used to detect the physiological measured variables as well as to operate the connected sensors 9, 10, 11, 12, 15, 16. The measuring transducers may be arranged both in the inspiration branch and the expiration branch as well as in the patient gas path of the Y-piece 1.

The electronic unit 13 is equipped with a display unit for checking and displaying the ability to function.

The main operating interface is arranged on the other side of the flexible breathing tube 3, namely, in the respirator or anesthesia apparatus 5.

In addition to the communication in the flexible breathing tube 3, a radio-supported communication of the measured data from the Y-piece 1 may be implemented as well, so that transmission of data to other analyzing units in a network is possible.

An energy storage means 14, for example, in the form of a battery, which possibly maintains the operation of the sensor system, is integrated in the Y-piece 1 for a bridging operation during manual respiration with a manual breathing bag, for example, during transportation of the patient. The solution proposed offers the advantage that the measured values from the physiological monitoring and the measured values of the respiration sensor system can be combined with one another in the respirator or anesthesia apparatus 5 with a substantially improved possibility of handling. Thus also applies to the analysis and the display of the measured values by means of a common user interface: For example, CO₂ concentration values from the expired air can be related to CO₂ or O₂ saturation values in the blood in a common analyzing unit. The Y-piece 1 represents a power station and a docking element or a data concentrator with measuring functionality. The number of cables, which lead away from the patient bed, is minimized and the guiding of the connection cables at the cable, for example, to the ECG electrodes, is improved.

The electronic unit 13 may be designed as a component that can be attached and plugged in mechanically or docked and reused, so that the pneumatic basic body of the Y-piece 1 can be autoclaved or washed separately.

As an alternative, the electronic unit may be embedded or incorporated in a pourable sealing compound of the Y-piece 1, which is preferably manufactured from a transparent plastic, so that the Y-piece 1 can be washed or autoclaved and used several times and continues to be able to be washed or autoclaved and used several times.

While a specific embodiment of the invention has been shown and described in detail to illustrate the application of the principles of the invention, it will be understood that the invention may be embodied otherwise without departing from such principles.

What is claimed is:

1. A Y-piece for a medical respiration system, the Y-piece comprising:
an inspiration branch;
an expiration branch;
a Y-piece contactless connection element portion; and
an electrical interface providing a connection between one or more sensors connected to said Y-piece and a contactless connection element portion of a flexible breathing tube connected to at least one of said inspiration branch and said expiration branch via said Y-piece contactless connection element portion.

2. A Y-piece in accordance with claim 1, wherein said connection element comprises an inductive or capacitive element.

3. A Y-piece in accordance with claim 1, wherein said electrical interface comprises an energy and data interface.

4. A Y-piece in accordance with claim 1, wherein said one or more sensors comprise at least one of carbon dioxide sensors, oxygen partial pressure sensors and temperature sensors and said electrical interface comprises electric outlets for ECG electrode cables and sensor connections of said sensors.

5. A Y-piece in accordance with claim 1, further comprising a mount for a sphygmomanometer cuff with a flexible tube.

6. A Y-piece in accordance with claim 1, further comprising a breath flow sensor arranged in a flow path of said Y-piece.

7. A Y-piece in accordance with claim 6, wherein said breath flow sensor comprises a sensor for detecting a velocity of gas passing through said flow path, for detecting a quantity of gas passing through said flow path, for detecting a type of gas passing through said flow path and/or for detecting a gas concentration of gas passing through said flow path.

8. A Y-piece in accordance with claim 6, wherein said breath flow sensor comprises one or more of a hot wire anemometer, an ultrasound anemometer and/or a differential pressure anemometer.

9. A Y-piece in accordance with claim 1, further comprising a pressure sensor for detecting respiration pressure.

10. A Y-piece in accordance with claim 1, further comprising an electronic unit for processing measured signals arriving from said one or more sensors.

11. A Y-piece in accordance with claim 10, wherein said electronic unit comprises at least one of:
an ECG operating electronic unit containing a differential amplifier, compensation circuits and an analog-digital converter and a control computer; and
an oxygen partial pressure operating electronic unit containing a LED driver and control, photodiode amplifier, analog-digital converter, and control computer.

12. A Y-piece in accordance with claim 10, further comprising an electrical energy storage means connected to said electronic unit.

13. A Y-piece in accordance with claim 1, further comprising another flexible breathing tube wherein each of said inspiration branch and said expiration branch are connected via said Y-piece contactless connection element portion to a respective said flexible breathing tube, each with inductive or capacitive connections.

14. A Y-piece in accordance with claim 1, wherein electrical interface elements comprising said electrical interface are embedded in a housing of said Y-piece.

15. A Y-piece in accordance with claim 14, wherein said electrical interface elements are designed in the form of a unit that can be attached to, plugged into or docked with the housing of said Y-piece.

16. A medical respiration system comprising:
a Y piece including a Y-piece housing defining an inspiration branch an expiration branch and a patient connection branch;
a Y-piece contactless connection element portion connected to one of said inspiration branch and said expiration branch;
an electrical interface connected to said Y-piece housing and connected to said Y-piece contactless connection element portion, said electrical interface having sensor connection means and providing a connection between said sensor connection means and said Y-piece contactless connection element portion;
one or more sensors connected to said connection means of said electrical interface;
a flexible breathing tube connected to at least one of said inspiration branch and said expiration branch; and
a tube contactless connection element portion operatively connected to said Y-piece contactless connection element portion.

17. A medical respiration system in accordance with claim 16, wherein said flexible breathing tube is connected to a pneumatic port of a respirator or anesthesia apparatus and said Y-piece contactless connection element portion and said tube contactless connection element portion form a connection element comprising an inductive or a capacitive element, said flexible breathing tube having wire lines associated therewith connecting to an electrical terminal for data exchange and a supply voltage and wherein said electrical interface comprises an energy and data interface.

18. A medical respiration system in accordance with claim 17, further comprising:
a mount for a sphygmomanometer cuff with a flexible tube;
a pressure sensor for detecting respiration pressure; and
a breath flow sensor arranged in a flow path of said Y-piece, wherein said one or more sensors comprise at least one of carbon dioxide sensors, oxygen partial pressure sensors and temperature sensors and said electrical interface comprises electric outlets for ECG electrode cables and sensor connections of said sensors.

19. A medical respiration system in accordance with claim 16, further comprising an electronic unit for processing measured signals arriving from said one or more sensors, wherein said electronic unit comprises at least one of:
an ECG operating electronic unit containing a differential amplifier, compensation circuits and an analog-digital converter and a control computer;
an oxygen partial pressure operating electronic unit containing a LED driver and control, photodiode amplifier, analog-digital converter, and control computer; and
an electrical energy storage means connected to said electronic unit.

20. A medical respiration system in accordance with claim 16, further comprising: electrical interface elements comprising said electrical interface embedded in a housing of said Y-piece, wherein said electrical interface elements are designed in the form of a unit that can be attached to, plugged into or docked with the housing of said Y-piece.
